(19) United States
(12) Patent Application Publication
(10) Pub. No.: US 2014/0248208 A1
(43) Pub. Date: Sep. 4, 2014

(54) CATALYST AND METHOD FOR PRODUCING CHLORINE BY MEANS OF A GAS-PHASE OXIDATION

(71) Applicant: BAYER INTELLECTUAL PROPERTY GMBH, Monheim (DE)

(72) Inventors: Timm Schmidt, Neuss (DE); Maximilian Moser, Zurich (CH); Walther Müller, Pulheim (DE)

(73) Assignee: BAYER INTELLECTUAL PROPERTY GMBH, Monheim (DE)

(21) Appl. No.: 14/351,895

(22) PCT Filed: Oct. 19, 2012
(86) PCT No.: PCT/EP2012/070771

§ 371 Date: Apr. 15, 2014

(30) Foreign Application Priority Data
Oct. 24, 2011 (DE) 10 2011 085 068.6

(51) Int. Cl. B01J 23/10; C01B 7/04

(52) U.S. Cl. CPC B01J 23/10; C01B 7/04
USPC 423/502; 502/303

(57) ABSTRACT

A catalyst material for producing chlorine by the catalytic gas-phase oxidation of hydrogen chloride, wherein the catalyst comprises oxide compounds of cerium as active component components and zirconium dioxide as supporting component and the catalyst h as a particularly high space-time yield with respect to the reactor volume

This is a 371 of PCT/EP2012/070771 filed Oct. 19, 2012 (International Filing Date), claiming priority of German application 10 2011 085 068.6 filed Oct. 24, 2011.

The invention proceeds from known catalysts comprising cerium or other catalytically active components for the preparation of chlorine by catalytic gas phase oxidation of hydrogen chloride with oxygen. The invention relates to a supported catalyst for preparation of chlorine by catalytic gas phase oxidation of hydrogen chloride with oxygen, in which the catalyst comprises at least oxide compounds of cerium as an active component and zirconium dioxide as a support component, and in which the catalyst features a particularly high space-time yield based on the reactor volume, measured in kg_{C12}/L_{REACTOR}·h.

### BACKGROUND OF THE INVENTION

The process developed by Deacon in 1868 for catalytic hydrogen chloride oxidation with oxygen in an exothermic equilibrium reaction was at the genesis of industrial chlorine chemistry:

4HCl+O₂ [symbol] 2Cl₂+2H₂O.

Chloralkali electrolysis, however, eclipsed the Deacon process to a substantial degree. Virtually all chlorine was produced by electrolysis of aqueous sodium chloride solutions [Ullmann Encyclopedia of industrial chemistry, seventh release, 2006]. However, the attractiveness of the Deacon process has been increasing recently, since global chlorine demand is growing faster than the demand for sodium hydroxide solution. This development is favorable for the process for preparing chlorine by oxidation of hydrogen chloride decoupled from the preparation of sodium hydroxide solution. In addition, hydrogen chloride is obtained as a coproduct in large amounts in phosgenation reactions for example, for instance in isocyanate preparation.

The first catalysts for HCl gas phase oxidation contained copper in the oxidic form as an active component and had been described by Deacon as early as 1868. These catalysts deactivated rapidly because the active component was lost through volatility at the high process temperatures.

HCl gas phase oxidation by means of chromium oxide-based catalysts is also known. However, chromium-based catalysts under oxidizing conditions have a tendency to form chromium(VI) oxides, which are very toxic and have to be kept out of the environment, with a high level of technical complexity. Furthermore, a short service life is implied in other publications (WO 2009/035234 A, page 4, line 10).

Ruthenium-based catalysts for HCl gas phase oxidation were described for the first time in 1965, but the activity of these RuCl₃SiO₂ catalysts was quite low (see: DE 1567788 A1). Further catalysts having the active components of the ruthenium dioxide, mixed oxides of ruthenium or ruthenium chloride in combination with various support oxides, such as titanium dioxide or tin dioxide, have also already been described (see, for example: EP 743277A1, U.S. Pat. No. 5,908,607, EP 2026905 A1 and EP 2027062 A2). In the case of ruthenium-based catalysts, the optimization of the support is accordingly already well-advanced.

Ruthenium-based catalysts have quite a high activity and stability at a temperature in the range of 350-400° C. However, the stability of ruthenium-based catalysts above 400° C. still has not been demonstrated unambiguously (WO 2009/035234 A2, page 5, line 17). Furthermore, the platinum group metal ruthenium is very scarce and very costly, and the price of ruthenium on the global market is highly variable. There is therefore a need for alternative catalysts having higher availability and comparable effectiveness.

WO 2009/035234 A2 describes cerium oxide catalysts for HCl gas phase oxidation (see claims 1 and 2); supporting is at least considered therein. However, possible suitable supports are not disclosed specifically.

The disclosure of DE 10 2009 021 675 A1 is considered to be the prior art closest to the invention and describes a process for preparing chlorine by catalytic oxidation of hydrogen chloride in the presence of a catalyst comprising an active component and optionally a support material, and wherein the active component comprises at least one cerium oxide compound. Example 5 of DE '675 describes a catalyst material comprising cerium oxide on lanthanum-zirconium oxide as a catalyst support, and gives a detailed description of the efficacy of this catalyst material in use example 11 of DE '675. It is apparent from DE '675 that the activity of this catalyst material is the lowest compared to all the other catalysts tested therein. Suitable support materials for the cerium oxide catalyst mentioned “by way of example” are the substances: silicon dioxide, aluminum oxide (e.g. in the α or γ polymorphs), titanium dioxide (as rutile, anatase etc.), tin dioxide, zirconium dioxide, uranium oxide, carbon nanotubes or mixtures thereof, in the absence of any further examples thereof or consideration of the advantages and disadvantages of the supports listed with respect to one another (see paragraph [0017] of DE '675). The aforementioned list is an arbitrary enumeration of support materials known per se for ruthenium catalysts in the HCl gas phase oxidation, which has been extended by addition of a known active component (uranium). The person skilled in the art of catalyst development infers from the disclosure of DE 10 2009 021 675 A1 that the use of cerium oxide in supported catalysts does not give a useful catalyst material.

It is thus an object of the present invention, proceeding from the aforementioned prior art, to find an improved catalyst material which is based on cerium rather than ruthenium, which is scarce, as the catalytically active component and has a significantly higher effectiveness in supported form. More particularly, one object is to identify, for the cerium oxide active component, an optimal catalyst support for use in HCl gas phase oxidation.

### SUMMARY OF THE INVENTION

The object is achieved by supporting oxide compounds of cerium on zirconium dioxide.

Specifically, it has been found that, surprisingly,
with a comparable loading of 7% by weight, the best new CeO₂/ZrO₂ catalyst (1.28 kg_{C12}/kg_{CAT}·h, ex. 5) has a space-time yield based on the catalyst mass 2.6 times higher than the best noninventive alternative catalyst (CeO₂/Al₂O₃: 0.49 kg_{C12}/kg_{CAT}·h, ex. 7); accordingly, the cerium active component in these novel CeO₂/ZrO₂ catalysts is utilized much better than in the case of other standard supports, and
the best new CeO₂/ZrO₂ catalyst (1.25 kg_{C12}/kg_{CAT}·h, ex. 6) has a space-time yield based on the reactor volume 4.3 times higher than the best noninventive alternative catalyst (CeO₂/Al₂O₃: 0.46 kg_{C12}/kg_{CAT}·h, ex. 24). The reactor volume is accordingly utilized much better in these novel CeO₂/ZrO₂ catalysts than is the case for other standard supports, which of course also has a positive effect on the pressure drop over the filled reactor and hence affects the power consumption in the operation of the HCl oxidation.

### DETAILED DESCRIPTION

The invention provides a catalyst material comprised of porous catalyst support and catalytic coating for a process for thermocatalytic preparation of chlorine from hydrogen chloride and oxygen-containing gas, said catalyst material at least comprising: at least one oxide compound of cerium as a catalytically active component and at least zirconium dioxide as a support component, characterized in that the lanthanum content in the form of La₂O₃ based on the calcined catalyst is less than 5% by weight, especially measured by the method of X-ray fluorescence analysis for the metal content and X-ray diffraction for detection of the oxide structure.

In a preferred execution, the novel catalyst material is characterized in that the calcined catalyst has a bulk density of at least 1000 kg/m³, preferably of at least 1200 kg/m³, more preferably of at least 1300 kg/m³, especially measured in a DN100 measuring cylinder with fill height 350 mm, and where the principal dimension of the particles of the catalyst material averages at least 0.5 mm, preferably at least 1 mm. Given equal space-time yield based on the catalyst mass, catalysts having high bulk density are preferable, since the minimum reactor volume required is inversely proportional to the bulk density. Since, for reasons of corrosion, technically complex and costly Ni-containing construction materials are generally used for the reactors, the increase in the catalyst bulk density may be a significant advantage, especially in the case of use in shell and tube reactors, in which the reactor construction may be reduced in size. As stated above, a reduced reactor volume also has a positive effect on the pressure drop over the filled reactor and hence the power consumption.

In a preferred execution, the catalyst support is comprised of zirconium dioxide to an extent of at least 50% by weight, preferably to an extent of at least 90% by weight, more preferably to an extent of at least 99% by weight, especially measured by the method of X-ray fluorescence analysis for the metal content and X-ray diffraction for detection of the oxide structure.

In a preferred execution, the novel catalyst material is characterized in that the lanthanum content in the form of La₂O₃, based on the calcined catalyst, is less than 3% by weight, preferably less than 2% by weight, more preferably less than 1% by weight, and it is most preferably essentially free of lanthanum constituents, especially measured by the method of X-ray fluorescence analysis for the metal content and X-ray diffraction for detection of the oxide structure. In a particularly preferred execution, the novel catalyst material is characterized in that the Y₂O₃ content, based on the calcined catalyst, is less than 5% by weight, especially measured by the method of X-ray fluorescence analysis for the metal content and X-ray diffraction for detection of the oxide structure. La₂O₃ and Y₂O₃, which are commonly used as structural stabilizers, appear to impair the particular interaction between CeO₂ and ZrO2 (see examples).

In a particularly preferred execution, the novel catalyst material is characterized in that the SO₃ content, based on the calcined catalyst, is less than 3% by weight, especially measured by the method of X-ray fluorescence analysis for the metal content and X-ray diffraction for detection of the oxide structure. Superacidic sites in the SO₃-doped ZrO₂ appear to be disadvantageous if anything for the space-time yield (see examples).

In a preferred execution, the novel catalyst material is characterized in that the porous catalyst support in the uncoated state (i.e. prior to application of the catalytic active component) has a bimodal pore radius distribution, where the median of a pore class 1 is preferably from 30 to 200 nm and the median of a pore class 2 is preferably from 2 to 25 nm, and where the median of a pore class 1 is more preferably from 40 to 80 nm and the median of a pore class 2 is more preferably from 5 to 20 nm, especially measured by means of mercury porosimetry. The pores of pore class 1 preferably also serve as transport pores during catalyst preparation, in order that the pores of pore class 2 can also be filled with the solvent comprising cerium compounds during preparation by means of dry impregnation (incipient wetness). The pores of pore class 1 preferably also serve as transport pores during HCl gas phase oxidation, in order that the pores of pore class 2 are also supplied adequately with feed gases and product gases are removed.

In a preferred execution, the novel catalyst material is characterized in that the catalyst support in the uncoated state (i.e. prior to application of the catalytic active component) has a surface area of 30 to 250 m²/g, preferably of 50 to 100 m²/g, especially measured by the method of nitrogen adsorption with BET evaluation.

Particular preference is given to using a novel ZrO₂ catalyst support having the following specifications:
specific surface area in the region of 55 m²/g (nitrogen adsorption, BET evaluation)
bimodal pore radius distribution where a pore class 1 (transport pores) has a median in the region of 60 nm and a pore class 2 (fine pores) has a median in the region of 16 nm (mercury porosimetry)
pore volume in the region of 0.27 cm³/g (mercury porosimetry)
bulk density in the region of 1280 kg/m³

Particular preference is given to using a novel ZrO₂ catalyst support having the following specifications:
specific surface area in the region of 85 m²/g (nitrogen adsorption, BET evaluation)
bimodal pore radius distribution where a pore class 1 (transport pores) has a median in the region of 60 nm and a pore class 2 (fine pores) has a median in the region of 8 nm (mercury porosimetry)
pore volume in the region of 0.29 cm³/g (mercury porosimetry)
bulk density in the region of 1160 kg/m³ (measured in a DN100 measuring cylinder with height 350 mm)

In a preferred execution, the novel catalyst material is characterized in that the zirconium dioxide support component is present in the monoclinic crystal form to an extent of at least 90% by weight, preferably to an extent of at least 99% by weight, especially estimated by means of X-ray diffraction.

In a preferred execution, the novel catalyst material is characterized in that the cerium content is 1 to 20% by weight, preferably 3 to 15% by weight and more preferably 7 to 10% by weight.

In a preferred execution, the novel catalyst material is characterized in that the oxide compounds of cerium are the exclusive catalytic active components on the catalyst support.

Preferred oxide compounds of cerium are Ce(III) oxide (Ce₂O₃) and cerium(IV) oxide (CeO₂). Under conditions for HCl gas phase oxidation, Ce—Cl structures (Ce chlorides) and also O—Ce—Cl structures (Ce oxychlorides) are to be expected at least at the surface.

In a preferred execution, the novel catalyst material is characterized in that the catalyst material is obtained by applying a cerium compound, especially from the group of cerium nitrate, acetate and chloride, to the support in solution by means of dry impregnation, and then drying the impregnated support and calcining it at relatively high temperature.

The coatings with catalytically active oxide compounds of cerium in the context of the invention are preferably obtainable by a process comprising first the application of a solution or suspension, especially an aqueous solution or suspension, of a cerium compound, preferably cerium nitrate, acetate or chloride, to the catalyst support, such that the solution is more preferably absorbed without residue by the catalyst support (also called “dry impregnation”), and the subsequent removal of the solvent. Preferably, the catalytic active component, i.e. the oxide compound of cerium, can alternatively also be applied to the support by precipitation and coprecipitation processes, and also ion exchange and gas phase coating (CVD, PVD).

The application of the cerium compound is generally followed by a drying step. The drying step is effected preferably at a temperature of 50 to 150° C., more preferably at 70 to 120° C. The drying time is preferably 10 min to 6 h. The catalysts can be dried under standard pressure or preferably under reduced pressure, more preferably 50 to 500 mbar (5 to 50 kPa), most preferably at about 100 mbar (10 kPa). Drying under reduced pressure is advantageous in order to be able to better fill pores having a small diameter <40 nm in the support with the preferably aqueous solution in the first drying step.

The drying is generally followed by a calcination step. Preference is given to calcining at a temperature of 600 to 1100° C., more preferably at 700 to 1000° C., most preferably at 850 to 950° C. The calcination is effected especially in an oxygen-containing atmosphere, more preferably under air. The calcination time is preferably 30 min to 24 h.

The uncalcined precursor of the novel catalyst can also be calcined in the reactor for the HCl gas phase oxidation itself, or more preferably under reaction conditions.

Preference is given to altering the temperature from one reaction zone to the next reaction zone. Preference is given to altering the catalyst activity from one reaction zone to the next reaction zone. Particular preference is given to combining the two measures. Suitable reactor designs are described, for example, in EP 1 170 250 B1 (=U.S. Pat. No. 6,977,066) and JP 2004099388 A. An activity and/or temperature profile can help to control the position and intensity of the hotspot.

The average reaction temperature in the novel catalyst for the purpose of HCl gas phase oxidation is preferably 300-600° C., more preferably 350-500° C. Much below 300° C., the activity of the novel catalyst is very low; much above 600° C., nickel alloys typically used as construction materials and unalloyed nickel do not have long-term stability with respect to the corrosive reaction conditions.

The exit temperature in the novel catalyst for the purpose of HCl gas phase oxidation is preferably not more than 450° C., more preferably not more than 420° C. A reduced exit temperature may be advantageous because the equilibrium for the exothermic HCl gas phase oxidation is then more favorable.

The O₂/HCl ratio is preferably equal to or greater than 0.75 in every part of the bed comprising the novel catalyst. From an O₂/HCl ratio equal to or greater than 0.75, the activity of the novel catalyst is maintained for longer than when the O₂/HCl ratio is lower.

Preference is given to raising the temperature in a reaction zone when the catalyst is deactivated. More preferably, the initial activity of the novel catalyst is partly to fully restored by a treatment with a higher O₂/HCl ratio than under regular conditions for the HCl gas phase oxidation, preferably at least twice as high, or under virtually HCl-free conditions (HCl/O₂ ratio=0), for example in air. More preferably, this treatment is conducted for up to 5 h at otherwise typical temperatures for the HCl gas phase oxidation.

Preferably, the novel catalyst is combined with a ruthenium catalyst on a separate support, using the ruthenium catalyst as a low-temperature component, preferably within the temperature range of 200-400° C., and the novel catalyst as a high-temperature component, preferably within the temperature range of 300-600° C. In this case, the two catalyst types are arranged in different reaction zones.

Preferably, as already described above, the novel catalyst composition is used in the catalytic process known as the Deacon process. In this process, hydrogen chloride is oxidized with oxygen in an exothermic equilibrium reaction to chlorine, forming water vapor. The typical reaction pressure is 1 to 25 bar, preferably 1.2 to 20 bar, more preferably 1.5 to 17 bar, most preferably 2 to 15 bar. Since this is an equilibrium reaction, it is appropriate to use oxygen in superstoichiometric amounts relative to hydrogen chloride. For example, a two- to four-fold oxygen excess is typical.

Since there is no risk of any selectivity losses, it may be economically advantageous to work at relatively high pressure and correspondingly with a longer residence time relative to standard pressure.

The invention therefore further provides a process for thermocatalytic preparation of chlorine from hydrogen chloride and oxygen-containing gas, characterized in that the catalyst used is a novel catalyst material described here. The invention also provides for the use of the novel catalyst material as a catalyst in the thermocatalytic preparation of chlorine from hydrogen chloride and an oxygen-containing gas.

The catalytic hydrogen chloride oxidation can preferably be performed adiabatically or isothermally or virtually isothermally, batchwise but preferably continuously, as a fluidized bed or fixed bed process, preferably as a fixed bed process, more preferably adiabatically at a pressure of 1 to 25 bar (1000 to 25 000 hPa), preferably 1.2 to 20 bar, more preferably 1.5 to 17 bar and especially preferably 2.0 to 15 bar.

A preferred process is characterized in that the gas phase oxidation is conducted isothermally in at least one reactor.

An alternative preferred process is characterized in that the gas phase oxidation is conducted in an adiabatic reaction cascade consisting of at least two series-connected adiabatic reaction stages with intermediate cooling.

Typical reaction apparatuses in which the catalytic hydrogen chloride oxidation is performed are fixed bed or fluidized bed reactors. The catalytic hydrogen chloride oxidation can preferably also be performed in a plurality of stages.

In the adiabatic, isothermal or virtually isothermal process regime, but preferably in the adiabatic process regime, it is also possible to use a plurality of, especially 2 to 10, preferably 2 to 6, reactors connected in series with intermediate cooling. The hydrogen chloride can either be added completely together with the oxygen upstream of the first reactor or distributed over the different reactors. This series connection of individual reactors can also be combined in one apparatus.

In a preferred execution, the novel catalyst is used for the purpose of HCl gas phase oxidation in an adiabatic reaction cascade comprised of at least two series-connected stages with intermediate cooling. Preferably, the adiabatic reaction cascade comprises 3 to 7 stages, including respective intermediate cooling of the reaction gases. More preferably, not all of the HCl is added upstream of the first stage; instead, it is distributed over the individual stages, in each case upstream of the respective catalyst bed, or especially preferably upstream of the respective intermediate cooling.

In a preferred execution, the novel catalyst is used for the purpose of HCl gas phase oxidation in an isothermal reactor, more preferably in just one isothermal reactor, more particularly in just one shell and tube reactor in flow direction of the feed gases. The shell and tube reactor is divided in flow direction of the feed gases preferably into 2 to 10 reaction zones, more preferably into 2 to 5 reaction zones. In a preferred execution, the temperature of a reaction zone is controlled by cooling chambers surrounding it, within which a cooling medium flows and removes the heat of reaction. A suitable shell and tube reactor is discussed in “Trends and Views in the Development of Technologies for Chlorine Production from Hydrogen Chloride”, SUMITOMO KAGAKU 2010-II, by Hiroyuki ANDO, Youhei UCHIDA, Kohei SEKI, Carlos KNAPP, Norihito OMOTO and Masahiro KINOSHITA.

A further preferred embodiment of an apparatus suitable for the process comprises using a structured catalyst bed in which the catalyst activity rises in flow direction. Such a structuring of the catalyst bed can be accomplished through different impregnation of the catalyst supports with active material or through different dilution of the catalyst with an inert material. The inert materials used may, for example, be rings, cylinders or spheres of titanium dioxide, zirconium dioxide or mixtures thereof, aluminum oxide, steatite, ceramic, glass, graphite or stainless steel. In the case of the preferred use of shaped catalyst bodies, the inert material should preferably have similar external dimensions.

Suitable shaped catalyst bodies include shaped bodies with any desired forms, preference being given to tablets, rings, cylinders, stars, wagonwheels or spheres, particular preference being given to rings, cylinders, spheres or star extrudates, as the form. Very particular preference is given to the spherical form. The size of the shaped catalyst bodies, for example diameter in the case of spheres or maximum principal dimension, is, on average, especially 0.5 to 7 mm, very preferably 0.8 to 5 mm.

In a preferred variant of the novel process, the cerium-containing catalyst material is combined with a catalyst comprising ruthenium or ruthenium compounds on a separate support, using the ruthenium catalyst as a low-temperature component, preferably within the temperature range from 200 to 400° C., and the cerium-containing catalyst material as a high-temperature component, preferably within the temperature range from 300 to 600° C.

More preferably, the two different catalyst types are arranged in different reaction zones.

The conversion of hydrogen chloride in the HCl oxidation in single pass can preferably be limited to 15 to 90%, preferably 40 to 90%, more preferably 70 to 90%. Unconverted hydrogen chloride can, after removal, be recycled partly or fully into the catalytic hydrogen chloride oxidation. The volume ratio of oxygen to hydrogen chloride at the reactor inlet is preferably 1:2 to 20:1, preferably 2:1 to 8:1, more preferably 2:1 to 5:1.

The heat of reaction of the catalytic hydrogen chloride oxidation can advantageously be utilized to raise high-pressure steam. This steam can be utilized to operate a phosgenation reactor and/or distillation columns, especially isocyanate distillation columns.

In a further step, the chlorine formed is removed. The removal step typically comprises a plurality of stages, specifically the removal and optional recycling of unconverted hydrogen chloride from the product gas stream of the catalytic hydrogen chloride oxidation, the drying of the resulting stream comprising essentially chlorine and oxygen, and the removal of chlorine from the dried stream.

Unconverted hydrogen chloride and steam formed can be removed by condensing aqueous hydrochloric acid out of the product gas stream of the hydrogen chloride oxidation by cooling. Hydrogen chloride can also be absorbed in dilute hydrochloric acid or water.

The examples which follow illustrate the present invention:

### EXAMPLES

In a comparison of catalysts on the laboratory scale, screen fractions are preferably used to directly measure the intrinsic activity of the catalyst, without needing to take account of the influence of different shaped body dimensions with different influence on mass transfer. According to current opinion, the reactor diameter should preferably be at least 10 times as large as the principal dimension of the particles of the catalyst material, in order to be able to neglect the influence of edge effects. When screen fractions are used, it is accordingly possible with preference to keep the laboratory reactors small.

In order not to allow the pressure drop to grow disproportionately, in a fixed bed reactor on the production scale, shaped bodies having a principal dimension of the particles of the catalyst material of at least 0.5 mm, more preferably at least 1 mm, are used.

Examples designated as inventive hereinafter were conducted with screen fractions, but it should be understood that these inventive catalysts in the process according the invention would always be used in the form of corresponding shaped bodies having a principal dimension of the particles of the catalyst material of at least 0.5 mm, more preferably of at least 1 mm.

The essential indices and results from the examples which follow are summarized in a table after the last example.

### Example 1

### Inventive

A ZrO₂ catalyst support (manufacturer: Saint-Gobain NorPro, product: SZ 31163, extrudates having diameter 3-4 mm and length 4-6 mm) in monoclinic structure was used, having the following specifications (prior to mortar crushing):
specific surface area of 55 m²/g (nitrogen adsorption, BET evaluation)
bimodal pore radius distribution where a pore class 1 (transport pores) has a median of 60 nm and a pore class 2 (fine pores) has a median of 16 nm (mercury porosimetry)
pore volume of 0.27 cm³/g (mercury porosimetry)
bulk density of 1280 kg/m³ (measured in a DN100 measuring cylinder with height 350 mm)

This ZrO₂ catalyst support (SZ 31163) was crushed with a mortar and classified into screen fractions. 1 g of the 100-250 μm screen fraction was dried at 160° C. and 10 kPa for 2 h. 50 g of cerium(III) nitrate hexahydrate were dissolved in 42 g of deionized water. 0.08 ml of the cerium(III) nitrate solution prepared in this way was initially charged in a snap-lid bottle, having been diluted with an amount of deionized water sufficient to fill the total pore volume, and 1 g of the dried screen fraction (100-250 μm) of the ZrO₂ catalyst support was stirred in until the initial charge of solution had been fully absorbed (dry impregnation methodology). The impregnated ZrO₂ catalyst support was then dried at 80° C. and 10 kPa for 5 h and then calcined in a muffle furnace in air. For this purpose, the temperature in the muffle furnace was increased in a linear manner from 30° C. to 900° C. within 5 h, and kept at 900° C. for 5 h. Thereafter, the muffle furnace was cooled in a linear manner from 900° C. to 30° C. within 5 h. The amount of cerium supported corresponds to a proportion of 3% by weight based on the calcined catalyst, calculating the catalyst components as CeO₂ and ZrO₂.

0.25 g of the catalyst prepared in this way was diluted with 1 g of Spheriglass (quartz glass, 500-800 μm) and initially charged in a fixed bed in a quartz reaction tube (internal diameter 8 mm), and a gas mixture of 1 L/h (standard conditions, STP) of hydrogen chloride, 4 L/h (STP) of oxygen and 5 L/h of nitrogen (STP) was allowed to flow through at 430° C. The quartz reaction tube was heated by an electrically heated oven. After 2 h, the product gas stream was passed into 30% by weight potassium iodide solution for 30 min. The iodine formed was then back-titrated with 0.1 N standard thiosulfate solution in order to determine the amount of chlorine introduced. A chlorine formation rate (space-time yield=STY) of 0.51 kg_{C12}/kg_{CAT}·h (based on the catalyst mass) or 0.68 kg_{C12}/L_{REACTOR}·h (based on the reactor volume filled with catalyst) was measured.

### Example 2

### Inventive

1 g of a catalyst was produced in accordance with example 1, except that the amount of cerium supported was adjusted to a proportion of 5% by weight based on the calcined catalyst. The catalyst was tested in accordance with example 1. A chlorine formation rate (STY) of 0.92 kg_{C12}/kg_{CAT}·h or 1.25 kg_{C12}/L_{REACTOR}·h was measured.

### Example 3

### Inventive

1 g of a catalyst was produced in accordance with example 1, except that the amount of cerium supported was adjusted to a proportion of 7% by weight based on the calcined catalyst. The catalyst was tested in accordance with example 1. A chlorine formation rate (STY) of 1.17 kg_{C12}/kg_{CAT}·h or 1.62 kg_{C12}/L_{REACTOR}·h was measured.

The catalysts based on undoped ZrO₂ as support material, given sufficient Ce loadings (ex. 3-6), have the best space-time yields (1.6-2.0 kg_{C12}/L_{REACTOR}·h). Up to a loading of 7-10% by weight, the space-time yield of these particularly preferred CeO₂/ZrO₂ catalysts based on the catalyst mass (active component support) rises in an approximately linear manner with the cerium content. At a loading of 10-20% by weight, the space-time yield based on the catalyst mass is approximately constant; the ZrO₂ catalyst support is saturated with active component.

### Example 4

### Inventive

1 g of a catalyst was produced in accordance with example 1, except that the amount of cerium supported was adjusted to a proportion of 10% by weight based on the calcined catalyst. The catalyst was tested in accordance with example 1. A chlorine formation rate (STY) of 1.27 kg_{C12}/kg_{CAT}·h or 1.82 kg_{C12}L_{REACTOR}·h was measured.

### Example 5

### Inventive

1 g of a catalyst was produced in accordance with example 1, except that the amount of cerium supported was adjusted to a proportion of 15% by weight based on the calcined catalyst. The catalyst was tested in accordance with example 1. A chlorine formation rate (STY) of 1.28 kg_{C12}/kg_{CAT}·h or 1.93 kg_{C12}/L_{REACTOR}·h was measured.

### Example 6

### Inventive

1 g of a catalyst was produced in accordance with example 1, except that the amount of cerium supported was adjusted to a proportion of 20% by weight based on the calcined catalyst. The catalyst was tested in accordance with example 1. A chlorine formation rate (STY) of 1.25 kg_{C12}/kg_{CAT}·h or 1.98 kg_{C12}/L_{REACTOR}·h was measured.

### Example 7

### Inventive

5 g of a catalyst were produced in accordance with example 1, except that (1) the ZrO₂ catalyst support was not crushed with a mortar prior to impregnation with the cerium nitrate solution, and was accordingly used in extrudate form (diameter 3-4 mm and length 4-6 mm), and (2) only after the calcination were the cerium-laden catalyst support extrudates crushed with a mortar and classified to screen fractions, of which the 100-250 μm screen fraction was used in the testing, and (3) the amount of cerium supported was adjusted to a proportion of 7% by weight based on the calcined catalyst. The catalyst was tested in accordance with example 1. A chlorine formation rate (STY) of 1.16 kg_{C12}/kg_{CAT}·h or 1.61 kg_{C12}/L_{REACTOR}·h was measured.

Examples 7-8 show that, even in the case of catalyst preparation by means of direct impregnation of the shaped catalyst support bodies, a similarly good space-time yield is achieved to that in the case of catalyst preparation by means of impregnation of the catalyst support screen fractions. Shaped catalyst support bodies are advantageously used to minimize the pressure drop in a fixed bed preferred in the HCl gas phase oxidation.

### Example 8

### Inventive

5 g of a catalyst were produced in accordance with example 7, except that the amount of cerium supported was adjusted to a proportion of 10% by weight based on the calcined catalyst. The catalyst was tested in accordance with example 7. A chlorine formation rate (STY) of 1.14 kg_{C12}/kg_{CAT}·h or 1.63 kg_{C12}/L_{REACTOR}·h was measured.

### Example 9

### Comparative Example

ZrO₂ catalyst support according to example 1 (SZ 31163) was crushed with a mortar and classified into screen fractions, of which the 100-250 μm screen fraction was used in the testing. The ZrO₂ catalyst support was tested in the same way as the catalyst in example 1. A chlorine formation rate (STY) of 0.00 kg_{C12}/kg_{CAT}·h or 0.00 kg_{C12}/L_{REACTOR}·h was measured. ZrO₂ supports without the CeO₂ active component are accordingly suitable only as a support and not as an active component.

### Example 10

### Inventive

A ZrO₂ catalyst support (manufacturer: Saint-Gobain NorPro, product: SZ 31164, extrudates having diameter 3-4 mm and length 4-6 mm) in monoclinic structure was used, having the following specifications (prior to mortar crushing):
specific surface area of 85 m²/g (nitrogen adsorption, BET evaluation)
bimodal pore radius distribution where a pore class 1 (transport pores) has a median of 60 nm and a pore class 2 (fine pores) has a median of 8 nm (mercury porosimetry)
pore volume of 0.29 cm³/g (mercury porosimetry)
bulk density of 1160 kg/m³ (measured in a DN100 measuring cylinder with height 350 mm)

This ZrO₂ catalyst support (SZ 31164) was pretreated (crushed with a mortar, classified, dried) in accordance with example 1 and then used to produce 1 g of a catalyst according to example 1, except that the amount of cerium supported was adjusted to a proportion of 3% by weight based on the calcined catalyst. The catalyst was tested in accordance with example 1. A chlorine formation rate (STY) of 0.51 kg_{C12}/kg_{CAT}·h or 0.61 kg_{C12}/L_{REACTOR}·h was measured.

### Example 11

### Inventive

1 g of a catalyst according to example 10 was produced, except that the amount of cerium supported was adjusted to a proportion of 5% by weight based on the calcined catalyst. The catalyst was tested in accordance with example 10. A chlorine formation rate (STY) of 0.66 kg_{C12}/kg_{CAT}·h or 0.81 kg_{C12}/L_{REACTOR}·h was measured.

### Example 12

### Inventive

1 g of a catalyst according to example 10 was produced, except that the amount of cerium supported was adjusted to a proportion of 7% by weight based on the calcined catalyst. The catalyst was tested in accordance with example 10. A chlorine formation rate (STY) of 0.78 kg_{C12}/kg_{CAT}·h or 0.99 kg_{C12}/L_{REACTOR}·h was measured.

The catalysts based on undoped ZrO₂ as support material, given sufficient Ce loadings (ex. 12-15), have the best space-time yields (1.0-1.7 kg_{C12}/L_{REACTOR}·h). Up to a loading of 7-10% by weight, the space-time yield of these particularly preferred CeO₂/ZrO₂ catalysts based on the catalyst mass (active component support) rises in an approximately linear manner with the cerium content. At a loading of 10-20% by weight, the space-time yield based on the catalyst mass is approximately constant; the ZrO₂ catalyst support is saturated with active component.

### Example 13

### Inventive

1 g of a catalyst according to example 10 was produced, except that the amount of cerium supported was adjusted to a proportion of 10% by weight based on the calcined catalyst. The catalyst was tested in accordance with example 10. A chlorine formation rate (STY) of 1.21 kg_{C12}/kg_{CAT}·h or 1.58 kg_{C12}/L_{REACTOR}·h was measured.

### Example 14

### Inventive

1 g of a catalyst according to example 10 was produced, except that the amount of cerium supported was adjusted to a proportion of 15% by weight based on the calcined catalyst. The catalyst was tested in accordance with example 10. A chlorine formation rate (STY) of 1.28 kg_{C12}/kg_{CAT}·h or 1.76 kg_{C12}/L_{REACTOR}·h was measured.

### Example 15

### Inventive

1 g of a catalyst according to example 10 was produced, except that the amount of cerium supported was adjusted to a proportion of 20% by weight based on the calcined catalyst. The catalyst was tested in accordance with example 10. A chlorine formation rate (STY) of 1.16 kg_{C12}/kg_{CAT}·h or 1.66 kg_{C12}/L_{REACTOR}·h was measured.

### Example 16

### Inventive

5 g of a catalyst were produced in accordance with example 10, except that (1) the ZrO₂ catalyst support was not crushed with a mortar prior to impregnation with the cerium nitrate solution, and was accordingly used in extrudate form (diameter 3-4 mm and length 4-6 mm) and (2) only after the calcination were the cerium-laden catalyst support extrudates crushed with a mortar and classified to screen fractions, of which the 100-250 μm screen fraction was used in the testing, and (3) the amount of cerium supported was adjusted to a proportion of 7% by weight based on the calcined catalyst. The catalyst was tested in accordance with example 10. A chlorine formation rate (STY) of 0.75 kg_{C12}/kg_{CAT}·h or 0.94 kg_{C12}/L_{REACTOR}·h was measured.

### Example 17

### Inventive

5 g of a catalyst were produced in accordance with example 15, except that the amount of cerium supported was adjusted to a proportion of 10% by weight based on the calcined catalyst. The catalyst was tested in accordance with example 15. A chlorine formation rate (STY) of 0.94 kg_{C12}/kg_{CAT}·h or 1.22 kg_{C12}/L_{REACTOR}·h was measured.

Examples 16-17 show that, even in the case of catalyst preparation by means of direct impregnation of the shaped catalyst support bodies, a similarly good space-time yield is achieved to that in the case of catalyst preparation by means of impregnation of the catalyst support screen fractions. Shaped catalyst support bodies are advantageously used to minimize the pressure drop in a fixed bed preferred in the HCl gas phase oxidation.

### Example 18

### Comparative Example

ZrO₂ catalyst support according to example 1 (SZ 31164) was crushed with a mortar and classified into screen fractions, of which the 100-250 μm screen fraction was used in the testing. The ZrO₂ catalyst support was tested in the same way as the catalyst in example 10. A chlorine formation rate (STY) of 0.00 kg_{C12}/kg_{CAT}·h or 0.00 kg_{C12}/L_{REACTOR}·h was measured. ZrO₂ supports without the CeO₂ active component are accordingly suitable only as a support and not as an active component.

### Example 19

### Inventive

A commercial CeO₂-doped ZrO₂ catalyst support (manufacturer: Saint-Gobain NorPro, product: SZ 61191, spheres of diameter 3 mm) in tetragonal structure was used, having the following specifications (prior to mortar crushing):
18% CeO₂, remainder ZrO₂
specific surface area of 110 m²/g (nitrogen adsorption, BET evaluation)
bimodal pore radius distribution where a pore class 1 (transport pores) has a median of 150 nm and a pore class 2 (fine pores) has a median of 4 nm (mercury porosimetry)
pore volume of 0.25 cm³/g (mercury porosimetry)
bulk density of 1400 kg/m³ (measured in a DN100 measuring cylinder with height 350 mm)

This CeO₂-doped ZrO₂ catalyst support (SZ 61191) was crushed with a mortar and classified into screen fractions. 1 g of the 100-250 μm screen fraction was dried at 80° C. and 10 kPa for 5 h and then calcined in a muffle furnace in air. For this purpose, the temperature in the muffle furnace was increased in a linear manner from 30° C. to 900° C. within 5 h, and kept at 900° C. for 5 h. Thereafter, the muffle furnace was cooled in a linear manner from 900° C. to 30° C. within 5 h. The amount of cerium corresponds to a proportion of 14.7% by weight based on the catalyst, calculating the catalyst components as CeO₂ and ZrO₂.

A commercial CeO₂-promoted ZrO₂ catalyst support (SZ 61191) was according to the crushed with a mortar and classified into screen fractions, of which the 100-250 μm screen fraction was used in the testing. The ZrO₂ catalyst support was tested in the same way as the catalyst in example 10. A chlorine formation rate (STY) of 0.07 kg_{C12}/kg_{CAT}·h or 0.08 kg_{C12}/L_{REACTOR}·h was measured.

The catalyst treated in this way was tested in accordance with example 1. A chlorine formation rate (STY) of 0.92 kg_{C12}/kg_{CAT}·h or 1.29 kg_{C12}/L_{REACTOR}·h was measured. CeO₂-doped ZrO₂ has a notable space-time yield compared to the best catalyst tested (1.29 kg_{C12}/L_{REACTOR}·h versus 1.82-1.98 kg_{C12}/L_{REACTOR}·h (examples 4-6)). Even though the active component has not been applied separately in this case, cerium should of course be regarded as the active component in this case. The example is accordingly also regarded as inventive.

### Example 20

### Comparative Example

A ZrO₂ catalyst support (manufacturer: Saint-Gobain NorPro, product: SZ 61156, spheres of diameter 3 mm) in tetragonal structure was used, having the following specifications (prior to mortar crushing):
10% La₂O₃, remainder ZrO₂
specific surface area of 120 m²/g (nitrogen adsorption, BET evaluation)
bimodal pore radius distribution where a pore class 1 (transport pores) has a median of 200 nm and a pore class 2 (fine pores) has a median of 5 nm (mercury porosimetry)
pore volume of 0.3 cm³/g (mercury porosimetry)
bulk density of 1300 kg/m³ (measured in a DN100 measuring cylinder with height 350 mm)

This ZrO₂ catalyst support (SZ 61156) was pretreated (crushed with a mortar, classified, dried) in accordance with example 1 and then used to produce 1 g of a catalyst according to example 1, except that the amount of cerium supported was adjusted to a proportion of 7% by weight based on the calcined catalyst and the catalyst components are calculated as CeO₂ and ZrO₂. The catalyst was tested in accordance with example 1. A chlorine formation rate (STY) of 0.09 kg_{C12}/kg_{CAT}·h or 0.12 kg_{C12}/L_{REACTOR}·h was measured.

La₂O₃, which is commonly used as a structural stabilizer, appears to impair the particular interaction between CeO₂ and ZrO₂. This comparative example shows that the inventors of DE '675 in example 5 chose an unsuitable catalyst support. Only catalysts based on the ZrO₂ support component in which the lanthanum content in the form of La₂O₃, based on the calcined catalyst, is less than 5% by weight and which are most preferably essentially free of lanthanum constituents have an exceptionally high activity.

### Example 21

### Comparative Example

An Al₂O₃ catalyst support (manufacturer: Saint-Gobain NorPro, product: SA 6976, extrudates having diameter 2-3 mm and length 4-6 mm) in y structure was used, having the following specifications (prior to mortar crushing):
specific surface area of 250 m²/g (nitrogen adsorption, BET evaluation)
bimodal pore radius distribution where a pore class 1 (transport pores) has a median of 500 nm and a pore class 2 (fine pores) has a median of 7 nm (mercury porosimetry)
pore volume of 1.05 cm³/g (mercury porosimetry)
bulk density of 460 kg/m³ (measured in a DN100 measuring cylinder with height 350 mm)

This Al₂O₃ catalyst support (SA 6976) was pretreated (crushed with a mortar, classified, dried) in accordance with example 1 and then used to produce 1 g of a catalyst according to example 1, except that the amount of cerium supported was adjusted to a proportion of 7% by weight based on the calcined catalyst and the catalyst components are calculated as CeO₂ and Al₂O₃. The catalyst was tested in accordance with example 1. A chlorine formation rate (STY) of 0.49 kg_{C12}/kg_{CAT}·h or 0.24 kg_{C12}/L_{REACTOR}·h was measured.

### Example 22

### Comparative Example

1 g of a catalyst was produced in accordance with example 19, except that the amount of cerium supported was adjusted to a proportion of 12.5% by weight based on the calcined catalyst. The catalyst was tested in accordance with example 19. A chlorine formation rate (STY) of 0.86 kg_{C12}/kg_{CAT}·h or 0.46 kg_{C12}/L_{REACTOR}·h was measured.

### Example 23

### Comparative Example

An Al₂O₃ catalyst support (manufacturer: Saint-Gobain NorPro, product: SA 3177, extrudates having diameter 3-4 mm and length 4-6 mm) in mixed γ, α, θ structure was used, having the following specifications (prior to mortar crushing):
specific surface area of 100 m²/g (nitrogen adsorption, BET evaluation)
monomodal pore radius distribution having a median of 10 nm (mercury porosimetry)
pore volume of 0.49 cm³/g (mercury porosimetry)
bulk density of 780 kg/m³ (measured in a DN100 measuring cylinder with height 350 mm)

This Al₂O₃ catalyst support (SA 3177) was pretreated (crushed with a mortar, classified, dried) in accordance with example 1 and then used to produce 1 g of a catalyst according to example 1, except that the amount of cerium supported was adjusted to a proportion of 7% by weight based on the calcined catalyst. The catalyst was tested in accordance with example 1. A chlorine formation rate (STY) of 0.47 kg_{C12}/kg_{CAT}·h or 0.40 kg_{C12}/L_{REACTOR}·h was measured.

### Example 24

### Comparative Example

A TiO₂ catalyst support (manufacturer: Saint-Gobain NorPro, product: ST 31119, extrudates having diameter 3-4 mm and length 4-6 mm) in anatase structure was used, having the following specifications (prior to mortar crushing):
specific surface area of 40 m²/g (nitrogen adsorption, BET evaluation)
monomodal pore radius distribution having a median of 28 nm (mercury porosimetry)
pore volume of 0.30 cm³/g (mercury porosimetry)
bulk density of 1200 kg/m³ (measured in a DN100 measuring cylinder with height 350 mm)

This TiO₂ catalyst support (ST 31119) was pretreated (crushed with a mortar, classified, dried) in accordance with example 1 and then used to produce 1 g of a catalyst according to example 1, except that the amount of cerium supported was adjusted to a proportion of 7% by weight based on the calcined catalyst. The catalyst was tested in accordance with example 1. A chlorine formation rate (STY) of 0.24 kg_{C12}/kg_{CAT}·h or 0.32 kg_{C12}L_{REACTOR}·h was measured.

### Example 25

### Comparative Example

A TiO₂—ZrO₂ catalyst support (manufacturer: Saint-Gobain NorPro, product: ST 31140, extrudates having diameter 3-4 mm and length 4-6 mm) was used, having the following specifications (prior to mortar crushing):
40% TiO₂ (anatase), remainder ZrO₂ (monoclinic-tetragonal),
specific surface area of 80 m²/g (nitrogen adsorption, BET evaluation)
trimodal pore radius distribution where a pore class 1 (transport pores) has a median of 121 nm, a pore class 2 has a median of 16 nm and a pore class 3 has a median of 11 nm (mercury porosimetry)
pore volume of 0.46 cm³/g (mercury porosimetry)
bulk density of 815 kg/m³ (measured in a DN100 measuring cylinder with height 350 mm)

This TiO₂—ZrO₂ catalyst support (ST 31140) was pretreated (crushed with a mortar, classified, dried) in accordance with example 1 and then used to produce 1 g of a catalyst according to example 1, except that the amount of cerium supported was adjusted to a proportion of 7% by weight based on the calcined catalyst. The catalyst was tested in accordance with example 1. A chlorine formation rate (STY) of 0.14 kg_{C12}/kg_{CAT}·h or 0.13 kg_{C12}L_{REACTOR}·h was measured.

### Example 26

### Inventive, Temperature Variation

The catalyst from example 3 was also tested under otherwise identical conditions at 350, 370, 410 and 450° C.: The following chlorine formation rates (STY) were obtained:
350° C.: 0.22 kg_{C12}/kg_{CAT}·h or 0.03 kg_{C12}/L_{REACTOR}·h
370° C.: 0.44 kg_{C12}/kg_{CAT}·h or 0.61 kg_{C12}/L_{REACTOR}·h
410° C.: 0.98 kg_{C12}/kg_{CAT}·h or 1.36 kg_{C12}/L_{REACTOR}·h
450° C.: 1.80 kg_{C12}/kg_{CAT}·h or 2.50 kg_{C12}/L_{REACTOR}·h

The essential indices and results from the examples adduced (except for ex. 26) are summarized in the table below.

| Ex. | Support | | Density | | | Ce | STY | STY |
|---|---|---|---|---|---|---|---|---|
| # | kg/m³ | Name | kg/m³ | Prep. | Test | % by wt. | g/gh | g/cm³h |
| 1 | ZrO2 | SZ 31163 | 1327 | SF | SF | 3 | 0.51 | 0.68 |
| 2 | ZrO2 | SZ 31163 | 1358 | SF | SF | 5 | 0.92 | 1.25 |
| 3 | ZrO2 | SZ 31163 | 1388 | SF | SF | 7 | 1.17 | 1.62 |
| 4 | ZrO2 | SZ 31163 | 1434 | SF | SF | 10 | 1.27 | 1.82 |
| 5 | ZrO2 | SZ 31163 | 1509 | SF | SF | 15 | 1.28 | 1.93 |
| 6 | ZrO2 | SZ 31163 | 1583 | SF | SF | 20 | 1.25 | 1.98 |
| 7 | ZrO2 | SZ 31163 | 1388 | extrudate | SF | 7 | 1.16 | 1.61 |
| 8 | ZrO2 | SZ 31163 | 1434 | extrudate | SF | 10 | 1.14 | 1.63 |
| 9 | ZrO2 | SZ 31163 | 1280 | SF | SF | 0 | 0.00 | 0.00 |
| (comp.) | | | | | | | | |
| 10 | ZrO2 | SZ 31164 | 1202 | SF | SF | 3 | 0.51 | 0.61 |
| 11 | ZrO2 | SZ 31164 | 1230 | SF | SF | 5 | 0.66 | 0.81 |
| 12 | ZrO2 | SZ 31164 | 1258 | SF | SF | 7 | 0.78 | 0.99 |
| 13 | ZrO2 | SZ 31164 | 1300 | SF | SF | 10 | 1.21 | 1.58 |
| 14 | ZrO2 | SZ 31164 | 1368 | SF | SF | 15 | 1.28 | 1.76 |
| 15 | ZrO2 | SZ 31164 | 1435 | SF | SF | 20 | 1.16 | 1.66 |
| 16 | ZrO2 | SZ 31164 | 1258 | extrudate | SF | 7 | 0.75 | 0.94 |
| 17 | ZrO2 | SZ 31164 | 1300 | extrudate | SF | 10 | 0.94 | 1.22 |
| 18 | ZrO2 | SZ 31164 | 1160 | SF | SF | 0 | 0.00 | 0.00 |
| (comp.) | | | | | | | | |
| 19 | (Zr—Ce)Ox | SZ 61191 | 1400 | SF | SF | 14 | 0.92 | 1.29 |
| 20 | (Zr—La)Ox | SZ 61191 | 1410 | SF | SF | 7 | 0.09 | 0.12 |
| (comp.) | | | | | | | | |
| 21 | Al2O3 | SA 6976 | 499 | SF | SF | 7 | 0.49 | 0.24 |
| (comp.) | | | | | | | | |
| 22 | Al2O3 | SA 6976 | 531 | SF | SF | 12.5 | 0.86 | 0.46 |
| (comp.) | | | | | | | | |
| 23 | Al2O3 | SA 3177 | 846 | SF | SF | 7 | 0.47 | 0.40 |
| (comp.) | | | | | | | | |
| 24 | TiO2 | SA 31119 | 1302 | SF | SF | 7 | 0.24 | 0.32 |
| (comp.) | | | | | | | | |
| 25 | (Ti—Zr)O2 | SZ 31140 | 884 | SF | SF | 7 | 0.14 | 0.13 |
| (comp.) | | | | | | | | |

### CONCLUSIONS

ZrO₂ supports without the CeO₂ active component have zero activity (examples 9 and 18) and are accordingly suitable only as a support and not as an active component.

CeO₂-doped ZrO₂ (example 19) has a notable space-time yield compared to the best catalyst system tested (1.29 kg_{C12}/L_{REACTOR}·h versus 1.82-1.98 kg_{C12}L_{REACTOR}·h (examples 4-6)). Even though the active component has not been applied separately in this case, cerium should of course be regarded as the active component in this case. The example is also regarded as inventive.

Al₂O₃ (ex. 21-23), TiO₂ (ex. 24) and ZrO₂—TiO₂ having low bulk density (ex. 25) are not optimal supports for CeO₂ (0.1-0.5 kg_{C12}/L_{REACTOR}·h). In the case of Al₂O₃, it is helpful neither to set monomodal nor bimodal pore radius distributions. It is surprising that TiO₂ appears to be entirely unsuitable as a support for CeO₂. TiO₂ is one of the preferred support materials for the ruthenium dioxide active component in HCl gas phase oxidation.

Nor is the La₂O₃, doped ZrO₂ (ex. 20) cited an optimal support for CeO₂ (0.1-0.5 kg_{C12}/L_{REACTOR}·h) La₂O₃, which is commonly used as a structural stabilizer, appears to impair the particular interaction between CeO₂ and ZrO₂. This comparative example shows that the inventors of DE '675 in example 5 chose an unsuitable catalyst support. Only catalysts based on the ZrO₂ support component in which the lanthanum content in the form of La₂O₃, based on the calcined catalyst, is less than 5% by weight and which are most preferably essentially free of lanthanum constituents have an exceptionally high activity.

The catalysts based on undoped ZrO₂ as support material, given sufficient Ce loadings (ex. 3-6 and 12-15), have the best space-time yields (1.6-2.0 kg_{C12}/L_{REACTOR}·h and 1.0-1.7 kg_{C12}/L_{REACTOR}·h respectively). Up to a loading of 7-10% by weight, the space-time yield of these two particularly preferred CeO₂ZrO₂ catalysts based on the catalyst mass (active component support) rises in an approximately linear manner with the cerium content. At a loading of 10-20% by weight, the space-time yield based on the catalyst mass is approximately constant; the ZrO₂ catalyst support is saturated with active component.

Given a comparable loading of 7% by weight, the best CeO₂ZrO₂ catalyst (1.28 kg_{C12}/kg_{CAT}·h, ex. 5) has a space-time yield based on the catalyst mass 2.6 higher than the best non-novel alternative catalyst (CeO₂Al₂O₃: 0.49 kg_{C12}/kg_{CAT}·h, ex. 7). The cerium active component is accordingly utilized much better in the case of these novel CeO₂ZrO₂ catalysts than in the case of other commonly used supports.

The best CeO₂ZrO₂ catalyst (1.98 kg_{C12}/L_{REACTOR}·h, ex. 6) has a space-time yield based on the reactor volume 4.3 higher than the best non-inventive alternative catalyst (CeO₂Al₂O₃: 0.46 kg_{C12}/L_{REACTOR}·h, ex. 24). The reactor volume is accordingly utilized much better in the case of these novel CeO₂ZrO₂ catalysts than in the case of other commonly used supports. A reduced reactor volume of course also has a positive effect on the pressure drop and hence the electricity consumption.

Examples 7-8 and 16-17 show that, even in the case of catalyst preparation by means of direct impregnation of the shaped catalyst support bodies, a similarly good space-time yield is achieved to that in the case of catalyst preparation by means of impregnation of the catalyst support screen fractions. Shaped catalyst support bodies are advantageously used to minimize the pressure drop in a fixed bed preferred in the HCl gas phase oxidation.

1. A catalyst material comprised of porous catalyst support and catalytic coating for a process for thermocatalytic preparation of chlorine from hydrogen chloride and oxygen-containing gas, said catalyst material comprising: at least one oxide compound of cerium as a catalytically active component and at least zirconium dioxide as a support component, and having a lanthanum content in the form of La₂O₃ based on the calcined catalyst of less than 5% by weight.

2. The catalyst material as claimed in claim 1, wherein the calcined catalyst has a bulk density of at least 1000 kg/m³, measured in a DN100 measuring cylinder with fill height 350 mm, and wherein the principal dimension of the particles of the catalyst material averages at least 0.5 mm.

3. The catalyst material as claimed in claim 1, wherein the catalyst support is comprised of zirconium dioxide to an extent of at least 50% by weight.

4. The catalyst material as claimed in claim 1, wherein the lanthanum content in the form of La₂O₃, based on the calcined catalyst, is less than 3% by weight.

5. The catalyst material as claimed in claim 1, wherein the porous catalyst support in the uncoated state has a bimodal pore radius distribution, where the median of a pore class 1 is from 30 to 200 nm and the median of a pore class 2 is from 2 to 25 nm, measured by means of mercury porosimetry.

6. The catalyst material as claimed in claim 1, wherein the catalyst support in the uncoated state has a surface area of 30 to 250 m²/g, measured by the method of nitrogen adsorption with BET evaluation.

7. The catalyst material as claimed in claim 1, wherein the zirconium dioxide support component is present in the monoclinic crystal form to an extent of at least 90% by weight.

8. The catalyst material as claimed in claim 1, wherien the cerium content is 1 to 20% by weight.

9. The catalyst material as claimed in claim 1, wherein the oxide compounds of cerium are the exclusive catalytic active components on the catalyst support.

10. The catalyst material as claimed in claim 1, wherein the oxide compounds of cerium are selected from the group consisting of Ce(III) oxide (Ce₂O₃) and cerium(IV) oxide (CeO₂).

11. The catalyst material as claimed in claim 1, wherein the catalyst material is obtained by applying a cerium compound selected from the group consisting of cerium nitrate, acetate and chloride to the support in solution by means of dry impregnation, and then drying the impregnated support and calcining it.

12. (canceled)

13. A process for thermocatalytic preparation of chlorine from hydrogen chloride and oxygen-containing gas, wherein the catalyst used is a catalyst material as claimed in claim 1.

14. The process as claimed in claim 13, wherein the gas phase oxidation is conducted isothermally in at least one reactor.

15. The process as claimed in claim 13, wherein the gas phase oxidation is conducted in an adiabatic reaction cascade comprising at least two series-connected adiabatic reaction stages with intermediate cooling.

16. The process as claimed in claim 13, wherein the cerium-containing catalyst material is combined with a catalyst comprising ruthenium or ruthenium compounds on a separate support, using the ruthenium catalyst as a low-temperature component, and the cerium-containing catalyst material as a high-temperature component.

17. The process as claimed in claim 16, wherein the two different catalyst types are arranged in different reaction zones.
